(19) United States
(12) Patent Application Publication
(10) Pub. No.: US 2003/0136217 A1
(43) Pub. Date: Jul. 24, 2003

(54) Anti-noise starter flywheel

(76) Inventors: Jean Bonnefous, Reze (FR); Frank Douillard, La Bernardiere (FR); Serge Gaudu, Montaigu (FR)

Correspondence Address: BACHMAN & LAPOINTE, P.C., 900 CHAPEL STREET, SUITE 1201, NEW HAVEN, CT, 06510, US

(21) Appl. No.: 10/305,564

(22) Filed: Nov. 26, 2002

(30) Foreign Application Priority Data
Dec. 4, 2001 (FR) 0115654

(51) Int. Cl. G05G 1/00

(52) U.S. Cl. 74/572

(57) ABSTRACT

The flywheel of all internal combustion engine comprises a support and a ring gear. The outer peripheral end of the support has a radial surface and the inner peripheral end of the ring gear has a complementary radial surface. An element of viscoelastic material is situated between the radial surface and the complementary radial surface in such a manner as to put under compression stress in the radial and axial directions.

The present invention relates to a flywheel suitable for meshing with a pinion of a starter used for starting an internal combustion engine, in particular for vehicles such as automobiles.

### BACKGROUND OF THE INVENTION

Flywheels are known of the type that comprises a support adapted to be mounted axially on the outlet shaft of the engine and a ring gear which possesses an inner peripheral end whereby it is fixed to the outer peripheral end of the support.

A large amount of noise is generated when starting an internal combustion engine. This noise is unpleasant not only for the driver and passengers of the vehicle, but also for passersby. Starting on multiple occasions makes this more unpleasant. This unpleasant sound tarnishes the image of the vehicle.

Starting noise is generated by the starter pinion penetrating into the ring gear of the flywheel, and then by those two parts meshing.

One of the causes of the high level of noise is the small gear ratio between the number of teeth on the starter pinion which usually comprises 7, 9, or possibly 11 teeth, and the number of teeth on the ring gear which comprises 95 to 150 teeth.

The noise generated in this way is transmitted firstly through the air (to a very small extent), and secondly by solid conduction, i.e. by transmission from the ring gear to the support and then to the crankshaft and finally to the remainder of the engine and gear box unit.

A solution proposed in the prior art is to increase the number of teeth on the pinion. Thus, certain starters have been made with pinions having 21 teeth. Nevertheless, the ratio still remains low and noise on starting persists.

Another solution is to use flywheels that are much more massive, and as a result generate noise at much lower frequencies which are therefore perceived as being less unpleasant: for a flywheel having a diameter of 220 millimeters (mm), the resonant frequency of the flywheel is close to 2000 Hz, whereas for a flywheel having a diameter of 300 mm, its resonant frequency is close to 1200 Hz. Since starting noise is due mainly to transmission through solids, the fact of lowering the resonant frequency of the flywheel makes it possible simultaneously to lower the frequency of starting noise that is at a frequency higher than the resonant frequency.

Nevertheless, for reasons of size and expense, that solution can be used only on top-of-the-range vehicles. Furthermore, it does not reduce the total sound power emitted: all it does is reduce the frequency of starting noise so that it occupies a range that is much easier to bear.

Another solution proposed in the state of the Art is to fix the ring gear to the support via a flexible plastics material bonded both to the ring gear and to the support. Although the entire ring gear then turns slightly relative to the support, the level of noise remains high and this turning of the ring gear leads to problems concerning the lifetime of such flywheels.

### OBJECT AND SUMMARY OF THE INVENTION

The problem posed is to reduce significantly the noise power generated when starting internal combustion engines.

According to the present invention, the flywheel of the above-specified type comprises an element of viscoelastic material situated between the radial surface situated at the outer peripheral end of the support and the complementary radial surface situated at the inner peripheral end of the ring so as to be put under compression stress at least in the radial and axial directions.

By putting a viscoelastic material element situated between the radial surface of the support and the complementary radial surface of the ring under stress in at least all of the directions of a right section of said element, the sound volume is reduced significantly: the noise power at a frequency situated above the resonant frequency of the flywheel (2000 Hz) is reduced by about 9 decibels (dB). In addition, some of the noise at a frequency lower than the resonant frequency of the flywheel is lowered in frequency.

### BRIEF DESCRIPTION OF THE DRAWING

Other features of the present invention appear from the following description of an embodiment given as a non-limiting example. In the drawing:

FIG. 1 is a radial section view of a flywheel constituting a first embodiment of the present invention; and

FIG. 2 is a radial section view of the peripheral end of a flywheel constituting a second embodiment of the present invention.

### MORE DETAILED DESCRIPTION

A flywheel 1 of an internal combustion engine is connected to the engine via a crankshaft 2. The flywheel 1 comprises a support 3 which is mechanically connected to the crankshaft 2, e.g. by bolts, and a ring gear 4 which is connected to the support 3 by means of an interference fit, by welding, or by any other mechanical assembly system, e.g. by bolting. The ring gear 4 is adapted to mesh with the pinion of the starter.

The support 3 and the ring gear 4 present respectively an outer peripheral end 5 and a complementary inner peripheral end 6, the inner peripheral end 6 of the ring gear 4 being fixed to the outer peripheral end 5 of the support 3.

The outer peripheral end 5 presents a peripheral surface 7 and a radial surface 8. Similarly, the inner peripheral end 6 presents a complementary peripheral surface 9 and a complementary radial surface 10.

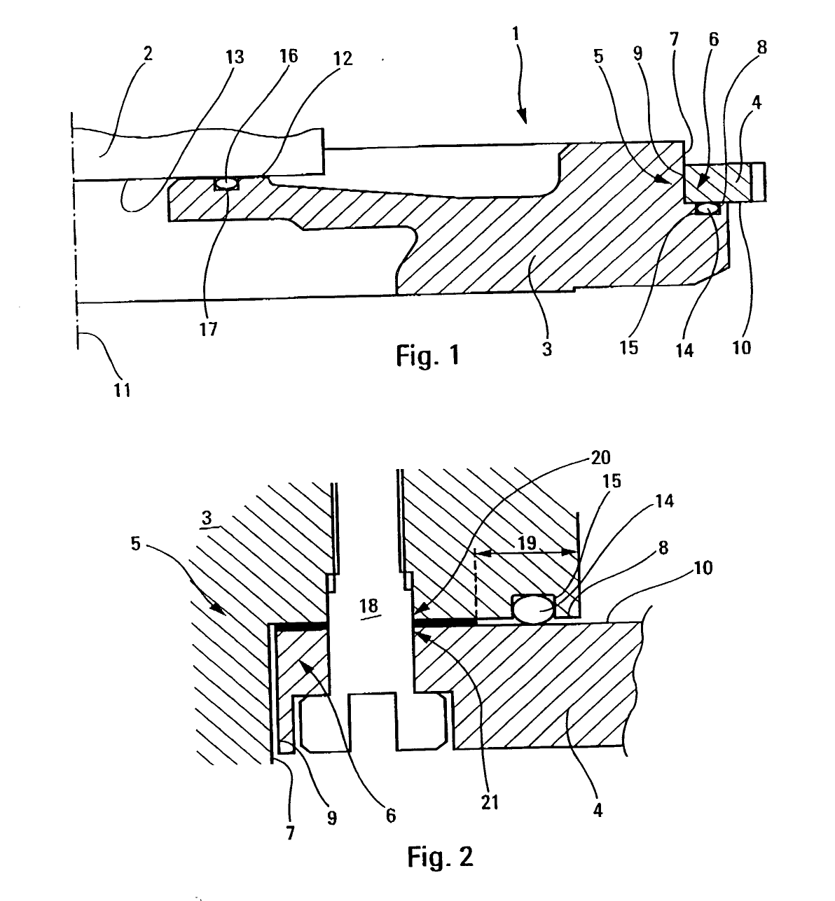

In the first embodiment shown in FIG. 1, the ring gear 4 is connected to the support 3 by fixing the complementary peripheral surface 9 to the peripheral surface 7. This fixing can be as an interference fit or by welding. It may be implemented by any of the means described in European patent application No. EP 00/402 629.0.

In the second embodiment shown in FIG. 2, the ring gear 4 is connected to the support 3 by fixing the complementary radial surface 10 to the radial surface 8 by means of screws 18: the peripheral surface 7 and the complementary peripheral surface 9 are spaced apart by clearance preventing these two surfaces coming into contact with each other and making it possible in particular to place the ring gear 4 around the surface 7.

Closer to the axis of rotation 11, the support 3 has a radial bearing surface 12 via which it is fixed to a radial reception surface 13 on the crankshaft 2.

In the present invention, an element 14 of viscoelastic material is placed between the radial surface 8 of the support 3 and the complementary radial surface 10 of the ring gear 4.

This element 14 of viscoelastic material is put under stress in all directions.

In the example shown in FIGS. 1 and 2, the element 14 of viscoelastic material is an annular gasket 14. The gasket 14 is inserted in an annular groove 15 formed in the radial surface 8 of the support 3, under stress in the radial and the axial directions.

The gasket 14 is put under stress in the groove 15, for example when the volume of the groove 15 is smaller than the volume of the gasket 14 by about 5%.

Putting the gasket 14 under stress In the annular groove 15 in all directions and causing said gasket 14 that is under stress to be in contact both with the radial surface 8 of the support 3 and with the complementary radial surface 10 of the ring gear 4 serves to reduce starting noise considerably. The gasket 14 that is under stress in the groove 15 absorbs a very large fraction of the vibration coming from the ring gear 4.

In the embodiment shown in FIG. 2, the annular groove 15 is made in a radial ring 19 which corresponds to the zone in which the radial surface 8 does not come into contact with the complementary radial surface 10 of the ring gear 4. Nevertheless, the gasket 14 does come into contact with the complementary radial surface 10 lying within said radial ring 19 and it is put under stress in the radial and axial directions in spite of the gap between the radial surface 8 and the complementary radial surface 10.

A flywheel 1 of the kind shown in FIG. 2 can be made, for example, as follows:

inserting the gasket 14 under stress in the annular groove 15 formed in the radial surface 8;

positioning the complementary radial surface 10 on the radial surface 8, the ring gear 4 and the support 3 having their axes of rotation coinciding with that of the flywheel 1;

piercing continuously in the axial direction each of the orifices 20 that opens out into the radial surface 8 and the complementary orifice 21 which extends it, thus enabling the ring gear 4 to be positioned angularly and radially relative to the support 3 without dimensional differences between the peripheral surface 7 and the complementary peripheral surface 9 being involved; and

inserting a screw 18 into each orifice 20 and the corresponding complementary orifice 21 so as to assemble together the complementary radial surface 10 of the ring gear 4 and the radial surface 8 of the support 3, the orifices 20 and the complementary orifices 21 naturally being in alignment because they were pierced continuously one into the other.

In a particular embodiment as shown in FIG. 1, an additional element 16 of viscoelastic material is also placed between the radial bearing surface 12 of the support 3 and the radial reception surface 13 of the crankshaft 2, and it comes into contact therewith.

This additional element 16 of viscoelastic material is put under stress in all directions like the element 14.

In the example shown in FIG. 1, the additional element 16 of viscoelastic material is an additional annular gasket 16. This additional gasket 16 is inserted under stress into an additional annular groove 17 formed in the radial bearing surface 12 of the support 3.

The additional gasket 16 is put under stress in the additional groove 17, for example when the volume of the additional groove 17 is less than the volume of the additional gasket 16 by about 5%.

By putting the additional gasket 16 under stress in all directions in the additional annular groove 17, and by causing the additional gasket 16 that is under stress to be in contact both with the radial bearing surface 12 of the support and with the radial reception surface 13 of the crankshaft, it is possible to achieve a further reduction in starting noise.

The ring gear 4 is fixed to the support 3 either via the peripheral surface 7 and the complementary peripheral surface 9 (as an interference fit or by welding), or else by means of bolts, and consequently a fraction of the vibration is transmitted front the ring gear 4 to the support 3 via said fixing means in spite of the presence of the gasket 14.

The additional gasket 16 serves to absorb a very large part of this residual vibration coming from the ring gear 4 and transmitted to the support 3.

By using a flywheel provided with an annular gasket 14 and with an additional annular gasket 16, the noise power on starting is considerably reduced.

This reduction is by about 9 dB for high frequency noise (frequency greater than 2000 Hz), i.e. noise at a frequency which is equal to or greater than the resonant frequency of the flywheel 1.

This reduction in sound volume is particularly appreciable where it concerns noise at frequencies that are deemed to be aggressive. In addition, this reduction in the general sound volume, and mainly at high frequencies, is accompanied by the frequency of some of the noise being reduced, in particular at frequencies that are slightly below the resonant frequency.

The viscoelastic material used for making the element 14 and the additional element 16 is constituted, for example, by a fluoro-elastomer, neoprene, silicone, nitrile-based polymers, etc.

In general, the material is such that its remanent deformation after being stresses lies in the range 10% to 20%.

It can be seen clearly from reading the above description that a major advantage of the present invention is that it can be applied to any type of starter flywheel and the extra cost thereof is very modest.

Finally, this invention can be used with other devices, for example isolating the starter by putting an elastic connection element into rotation together with the pinion and the starter shaft, which element can be a spring or a damper made of elastomer so as to decouple vibrations transmitted via a solid path, by putting a plate of elastomer between the starter and the engine or the clutch casing, by using fixing screws and an indexing peg made of a plastics material, or by covering the starter body in sound-insulating lagging, etc.

Associating all of the above techniques in combination with the present invention makes it possible to reduce noise power on starting by as much as 12 dB, and for noise at high frequencies (higher than 2000 Hz) by as much as 25 dB.

More precisely, measurements performed by the Applicant show that the flywheel of the present invention significantly reduces both the noise due to the teeth of the pinion penetrating between the teeth of the ring gear, and also meshing noise.

Naturally, the invention is not limited to the embodiments described in detail above, and numerous changes and modifications can be made thereto without going beyond the ambit of the invention. For example, it would be entirely possible to make the annular groove 15 in the complementary radial surface 10 of the ring gear 4 or to make the additional groove 17 in the radial reception surface 13 of the crankshaft 2.

What is claimed is:

1/ A flywheel for an internal combustion engine, the flywheel comprising a support suitable for being mounted axially on an outlet shaft of the engine and a ring gear possessing an inner peripheral end whereby it is fixed to an outer peripheral end of the support, the outer peripheral end of the support having a radial surface, and the inner peripheral end of the ring gear having a complementary radial surface, wherein an element of viscoelastic material is situated between the radial surface of the support and the complementary radial surface of the ring gear in such a manner as to be put under compression stress in the radial and axial directions.

2/ A flywheel according to claim 1, wherein an annular groove is made in the radial surface or in the complementary radial surface, with an annular gasket of viscoelastic material being housed under compression stress in said groove.

3/ A flywheel according to claim 2, wherein the volume of the groove is smaller than the volume of the annular gasket by about 5%.

4/ A flywheel according to claim 1, the support having a radial bearing surface whereby it is fixed to a radial reception surface of a member secured to the outlet shaft of the engine, wherein an additional element of viscoelastic material is situated between the radial bearing surface of the support and the radial reception surface of the member so as to be put under compression stress in the axial and radial directions.

5/ A flywheel according to claim 4, wherein an additional annular groove is made in the radial bearing surface or in the radial reception surface, and an additional annular gasket of viscoelastic material is received under compression stress in said additional groove.

6/ A flywheel according to claim 5, wherein the volume of the additional groove is smaller than the volume of the additional annular gasket by about 5%.

7/ A flywheel according to claim 1, wherein the ring gear is connected to the support by fixing the complementary peripheral surface of the ring gear to the peripheral surface of the annular support.

8/ A flywheel according to claim 1, wherein the ring gear is connected to the support by fixing the complementary radial surface to the radial surface by bolting.

9/ A method of manufacturing a flywheel by assembling a ring gear possessing An inner peripheral end having, in radial section, a radial surface that is complementary to a support possessing an outer peripheral end having, in radial section, a radial surface, wherein the following steps are performed:
inserting an annular gasket under stress into an annular groove formed in the radial surface;
positioning the complementary radial surface coaxially on the radial surface;
continuously piercing orifices opening out into the radial surface and complementary orifices opening out into the complementary radial surface and extending said orifices along the direction of the axis of rotation of the flywheel; and
inserting a bolt into each first orifice and the complementary orifice corresponding thereto so as to assemble the complementary radial surface to the radial surface.

10/ An engine including a flywheel according to claim 1.

11/ An engine according to claim 10, wherein a plate of elastomer is situated between the starter and the engine block.

12/ An engine according to claim 10, wherein the starter is wrapped in sound insulating lagging
